(19) United States
(12) Patent Application Publication
(10) Pub. No.: US 2024/0032454 A1
(43) Pub. Date: Feb. 1, 2024

(54) Methods And Systems For Use In Scan-Based Analysis Of Crops

(71) Applicant: Monsanto Technology LLC, Saint Louis, MO (US)

(72) Inventors: Steven James BALDWIN, Ellisville, MO (US); Robert Paul BRAUER, Lincoln, NE (US); Akash Dev NAKARMI, Saint Charles, MO (US); Anju Panicker Madhusoodhanan SATHIK, Chesterfield, MO (US); Minghui SUN, Woodland, CA (US)

(21) Appl. No.: 18/226,703

(22) Filed: Jul. 26, 2023

(30) Foreign Application Priority Data
Jul. 29, 2022 (IN) 202211043556

(51) Int. Cl. A01B 79/00; G01S 17/89; G06T 17/05

(52) U.S. Cl. CPC A01B 79/005; G01S 17/89; G06T 17/05

(57) ABSTRACT

Systems and methods for adjusting yield values for crops based on scan data associated with the crops are provided. One example computer-implemented method includes initially classifying data points of a composite data set into one of a ground class and a vegetation class. The method also includes determining a canopy height model (CHM) for the plot based on the classified composite data set, where the CHM includes at least one of the data points classified in the vegetation class, and computing a plant height for the plot based on the CHM. The method further includes determining a neighboring plant height difference based on the plant height for the plot and a plant height for each of at least one neighboring plot to said plot, computing a yield adjustment based on the determined neighboring plant height difference(s), and determining a plot yield for the plot, based on the yield adjustment.

### CROSS-REFERENCE TO RELATED APPLICATION

This application claims the benefit of, and priority to, Indian Patent Application No. 202211043556, filed Jul. 29, 2022. The entire disclosure of the above application is incorporated herein by reference.

### FIELD

The present disclosure generally relates to methods and systems for use in scan-based analysis of crops, in connection with determining, for example, crop yield characteristics, etc., of the crops, and more particularly, to sensor-based interpretation of neighboring plot effects in such determinations.

### BACKGROUND

This section provides background information related to the present disclosure which is not necessarily prior art.

Crops are planted, grown, and harvested in various different regions. After planting the crops, depending on types of the crops, the crops progress through various growth stages until they are harvested. At the time of harvest, or prior, a grower may take measurements of different characteristics of the crops, such as, for example, height, moisture content, etc., where the characteristics may be correlated to the performance of the crops. The measurements are known to be manual, whereby labor is disposed in the fields in order to carry out the measuring.

### SUMMARY

This section provides a general summary of the disclosure and is not a comprehensive disclosure of its full scope or all of its features.

Example embodiments of the present disclosure generally relate to methods for processing scan data associated with one or more plots and for adjusting yield values for crops in the one or more plots based on the scan data associated with the one or more crops. In one example embodiment, such a method generally includes: classifying, by a computing device, data points of a composite data set into one of multiple classes, the composite data set specific to a plot, each of the data points specific to a surface location of the plot, the multiple classes including a ground class and a vegetation class; determining, by the computing device, a canopy height model (CHM) for said plot based on the classified composite data set, the CHM including at least one of the data points classified in the vegetation class; computing, by the computing device, a plant height for the plot based on the CHM; determining, by the computing device, a neighboring plant height difference based on the plant height for the plot and a plant height for each of at least one neighboring plot to said plot; computing, by the computing device, a yield adjustment based on the determined neighboring plant height difference(s); and determining, by the computing device, a plot yield for the plot, based on the yield adjustment.

Example embodiments of the present disclosure also generally relate to systems for processing scan data associated with one or more plots and for adjusting yield values for crops in the one or more plots based on the scan data associated with the one or more crops. In one example embodiment, such a system includes a computing device, which is configured, by executable instructions, to: classify data points of a composite data set into one of multiple classes, the composite data set specific to a plot, each of the data points specific to a surface location of the plot, the multiple classes including a ground class and a vegetation class; determine a canopy height model (CHM) for said plot based on the classified composite data set, the CHM including at least one of the data points classified in the vegetation class; compute a plant height for the plot based on the CHM; determine a neighboring plant height difference based on the plant height for the plot and a plant height for each of at least one neighboring plot to said plot; compute a yield adjustment based on the determined neighboring plant height difference(s); and determine a plot yield for the plot, based on the yield adjustment.

Example embodiments of the present disclosure also generally relate to non-transitory computer-readable storage media including executable instructions for processing scan data associated with crops, which when executed by at least one processor, cause the at least one processor to perform one or more of the operations recited in the example method and/or example system above and/or herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for adjusting yield values for crops based on scan data from fields in which the crops are disposed;

FIG. 2 is a block diagram of an example computing device that may be used in the system of FIG. 1;

FIG. 3 illustrates a flow diagram of an example method, which may be used in (or implemented in) the system of FIG. 1, for use in adjusting yield values for crops based on scan data associated with the crops;

FIG. 4 illustrates an example canopy height model image, which may be generated through the method of FIG. 3;

FIG. 5 illustrates example best linear unbiased prediction (BLUP) values for yield values for crops adjusted in accordance with the system of FIG. 1 and/or the method of FIG. 3, based on scan data from fields in which the crops are disposed, in comparison to BLUP values for yield values for crops that are not adjusted based on such scan data; and

FIG. 6 illustrates example heritability/repeatability values associated with plant height values obtained based on scan data herein and heritability/repeatability values associated with plant height values obtained through manual measurements.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In assessing crops in plots and/or fields (broadly, growing spaces), different measurements may be captured for the crops. The measurements may be manual, for example, whereby a person is disposed in the plot and/or field capturing measurements of the crops. Height, for example, is one measurement of interest in connection with assessing the crops. The use of persons to measure the height of the crops (e.g., plants included in the crops, etc.), such as, for example, corn, is generally labor intensive and/or subject to error and/or tendencies (or biases) of the persons involved in the measurements. When the measurements are inaccurate, decisions relying of the measurements, in turn, may be incorrect.

Uniquely, the systems and methods herein leverage specific scan data to determine height models for plots (e.g., for crops growing in the plots, etc.) and to adjust yield values for the crops in the plots based on the height models. In particular, a computing device accesses and leverages scan data, including light detection and ranging (LiDAR) data, for certain fields, to generate canopy height models for the fields (e.g., by leveraging automated LiDAR data as compared to manual measurements to eliminate and/or minimize human impact on the data, etc.). The canopy height models may then be used as a basis to create yield adjustments for the fields and/or between different fields (e.g., neighboring fields, adjacent fields, etc.) to provide for more accurate comparisons of the crops in the different fields (e.g., impact of neighboring crop height on yield in the fields, etc.). In this way, the updated and/or adjusted height data for the crops may be incorporated into subsequent crop-based decisions to obtain more accurate results.

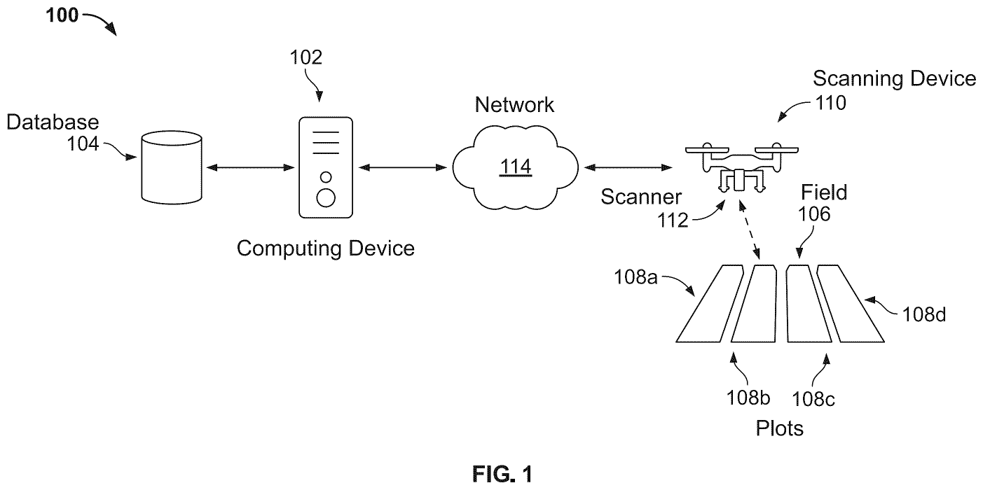

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, sources and/or types of data, arrangements of plots, types of crops in the plots, etc.

In the example embodiment of FIG. 1, the system 100 generally includes a computing device 102 and a database 104. The database 104 is coupled to (and/or otherwise in communication with) the computing device 102, as indicated by the arrowed line. The computing device 102 is illustrated as separate from the database 104 in FIG. 1, but it should be appreciated that the database 104 may be included, in whole or in part, in the computing device 102 in other system embodiments.

The system 100 also includes an example field 106. The field 106, in general, is provided for planting, growing, and harvesting crops, etc. The field 106 may include any different area, for its intended purpose. In this example embodiment, the field 106 is associated with one or more breeding pipelines, whereby multiple different variations or varieties of a crop, or multiple crops, may be planted in the field 106. In such examples, where multiple different varieties (or treatments) are included, the field 106 may be divided into different plots. As shown in FIG. 1, for example, the field 106 is divided (e.g., geographically, etc.) into four different plots 108a-d, where each is associated with a specific variety of a crop (e.g., corn, etc.) (or crops), or a specific treatment, in this example embodiment. For example, the field 106 may include four different hybrids of a crop (e.g., of corn, etc.), where each of the plots 108a-d is planted with a different variety of hybrid. In a different example, the field 106 may include two different varieties, which plots 108a-b include one variety and plots 108c-d including a different variety (but then with only plots 108a and 108c exposed to one or more treatments). The plots 108a-d are then subdivided into rows of the crop. In the illustrated embodiment, the plots 108a-d may include one to four rows of the crop, for example, that extend the length of the field 106 (or other length). The rows of crops/plants with the plots 108a-d may be spaced apart, for example, about 10 inches or more, about 20 inches or more, about 30 inches or more, about 40 inches or more, etc. In addition, the plots 108a-d, for example (and without limitation), may have an area ranging from about one meter to about twenty meters in width (or about 3 feet to about 70 feet), or more or less, and/or from about one meter to about forty-five meters in length (or about 3 feet to about 150 feet), or more or less. In one example embodiment, each of the plots 108a-d includes two rows of plants, with the plants spaced between about 20 inches and about 30 inches apart and with a width of the plots of about five feet and a length of about 22.5 feet. It should be appreciated, however, that fields and/or plots therein may have different dimensions, areas, etc., and that rows within the plots and/or fields may have different spacings, as suited to a particular crop, breeding or farming purpose, in other embodiments.

What's more, while only one field 106 and four plots 108a-d are shown in the system 100 in FIG. 1 for ease of reference, it should be appreciated that more fields may be included in other system embodiments, and that the field(s) may include more or less than four plots. For example, in at least one embodiment, a system may include on the order of dozens, or hundreds of fields, each having ten or more plots, where the plots together cover several acres (e.g., 1 acre, 10 acres, 50 acres, 100 acres, 200 acres, 1000 acres, or more or less, etc.). In general, the field 106, or multiple fields, may be any growing space sufficient to plant, grow and assess crops therein sufficient to satisfy one or more goals of the breeding pipeline of which they are a part, or of a farming operation. In this manner, it should also be understood that fields (and plots) may be used herein to refer to any growing spaces, in general, which are sufficiently accessible to be scanned as described herein, etc.

In this example embodiment, as generally described above, the different plots 108a-d in the field include different varieties of a crop. In connection therewith, the different plots 108a-d (and the different varieties of the crop therein) are generally subjected to various measurements, tests and/or monitoring (as described in more detail below), whereby data derived therefrom may then be used in making selections among the varieties of the crop included in the plots 108a-d.

The crops (or plants) planted in the field 106 (and included in one or more of the plots 108a-d) may include, for example (and without limitation), corn (or maize), wheat, beans (e.g., soybeans, etc.), peppers, tomatoes, tobacco, eggplant, rice, rye, sorghum, sunflower, potatoes, cotton, sweet potato, coffee, coconut, pineapple, citrus trees, prunes, cocoa, banana, avocado, fig, guava, mango, olive, papaya, cashew, almond, sugar beets, sugarcane, oats, barley, vegetables, or other suitable crop or products or combinations thereof, etc. In addition, the plots 108a-d of the field 106 may each include the same type of plants/crop, or a number of different varieties of the same type of plants (or crop), or different types and/or combinations of plants/crops. For example, plots 108a-b may include a first hybrid maize plant, while plots 108c-d may include a second, different hybrid maize plant. It should be appreciated that the plots 108a-d of the field 106 may be located in proximity to one another, or not. That said, in general, in various embodiments the same type of crop will be planted in the plots 108a-d adjacently to facilitate the yield adjustment described herein.

As further shown in FIG. 1, the system 100 includes a scanning device 110. As shown, the scanning device 110 includes an unmanned aerial vehicle (UAV) (e.g., a UAV, etc.), which includes a scanner 112 and, in particular in this example embodiment, a LiDAR (light detection and ranging) scanner. As such, the scanning device 110 is configured to travel/fly above the plots 108a-d in the system 100, for example, and to pulse laser beams, via the scanner 112, at the plots 108a-d and then capture, via the scanner 112, the reflected light as measurements of the surfaces of the plots 108a-d (e.g., ground, stalks, leaves, etc.). The measurements indicate distances, based on time, and are defined as point data for the field 106, for example, whereby a surface representation of the field 106 (and the plots 108a-d therein) is defined by the points. That is, the data points are surface locations of each of the specific plots 108a-d, or more generally, the field 106. In one or more example embodiments, the scanning device 110 may include a M600 UAV with real time kinetics and GPS integration by DJI (Da-Jiang Innovations), or an equivalent, and the scanner 112 may include a Scout scanner from PLS Operations, LLC d/b/a Phoenix LiDAR Systems, or an equivalent. The scanning device 110 and/or the scanner 112 may be different in other embodiments.

In various embodiments, the scanning device 110 is further equipped with a camera (broadly, a camera input device), whereby the scanning device 110 is further configured, via the camera, to capture images of the plots 108a-d, including, for example, red-green-blue (RGB) images, infrared images, other images, etc., and to associate the image data (e.g., the RGB color, etc.) with the point data from the scanner 112. Such image data may be stored in the database 104 (e.g., via the scanning device 110, via communication between the scanning device 110 and the computing device 102, etc.). In turn, the computing device 102 may be configured to use the image data, for example, in connection with generating colored point clouds for use in estimating, determining, etc. biomass in the field 106 (e.g., in the plots 108a-d, etc.), leaf area indices, etc. Further, the computing device 102 may be configured to use the image date in connection with generating an RGB orthomosaic, for example, for use in validating green snap and/or lodging metrics for the field 106 and/or plots 108a-d, etc.

In the illustrated embodiment, the scanning device 110 is configured to scan the field 106 late in the growing season of the crop(s), for example, when a phenology of the crop(s) in the field 106 indicates a maximum height of the crop(s), or within one or more growth stages of the crops in the field 106 in which a maximum height could be reached. In other embodiments, the scanning device 110 may be configured to scan the field 106 at one or more additional and/or other times, for example, at other growth stages of the crop(s) in the field 106 depending on, for example, the type of the crop(s), the basis to evaluate the scan (s) (e.g., height determination, etc.), or other suitable factors, etc.

In general, when the scanning device 110 traverses the field 106, and potentially, neighboring fields, to produce scan data for the field 106, the scanning device 110 may be configured to make multiple passes over the field 106 (e.g., as defined by geo-spatial data, etc.) and/or abide by flight lines to ensure that sufficient scan data for the field 106 is captured. The flight lines may make a serpentine path back and forth along the field 106 (e.g., in the direction of the rows and/or perpendicular to the rows, etc.), and may include multiple, intersecting lines to capture duplicate point data for each location of the field 106 (which is also captured and stored by the scanning device 110), etc. In addition, the scanner 112 may be configured to obtain location data for each of the captured data points (e.g., based on location/position data of the scanning device 110 (e.g., via a GPS unit of the scanning device 110, etc.), etc.) which may be corrected and/or refined, as needed, utilizing position correction hardware in the form of a ground station, etc. Further, the scanner 112 may be configured to provide for data fusion with regard to the captured data points in connection with and/or prior to conveying (e.g., transmitting, downloading, etc.) the captured data to the database 104 and/or computing device 102. In connection therewith, the scanning device 110 is configured to capture the scan data as part of a scan event, which encompasses a time interval to scan the field 106, alone or in combination with one or more other scanning devices (e.g., one or more other UAVs, etc.). The scan data for the event is then designated as representative of the field 106 and/or plots 108a-d in the field 106 (and potentially neighboring field/plots) at a point in time (e.g., relative to the growth stage of the crop, etc.).

In addition to the flight lines, the scanning device 110 is also configured to abide by a specific altitude (or altitude range), at which the scanner 112 is permitted, enabled and/or optimized to operate as described herein.

Further, the scanning device 110 is configured to store the scan data for the event, and to transmit the scan data to the database 104, directly or via the computing device 102, via network 114, etc., whereby the database 104 is configured to receive and store the scan data. It should be appreciated that the scan data from the scanning device 110 is stored in the database 104 for multiple seasons for the field 106 and various other fields.

While only scanning device UAV 110 is illustrated in FIG. 1, for purposes of simplicity, it should be appreciated that the system 100 may include (and in several implementations will include) multiple such scanning devices. What's more, the scanning device 110 is not limited to the UAV, whereby the system 100 may include one or more additional, alternate mobile scanning devices (e.g., manned aerial vehicles (MAVs), etc.), or fixed scanning device (e.g., pedestal mounted, tower mounted, etc.). Consistent with the above, the scanning devices, whether mobile or not, are configured, like the scanning device 110, to capture scan data for associated fields and to store scan data for the associated fields in the database 104. It should further be appreciated that the scanning device 110 should not be understood to be limited specifically to LiDAR technology, as other similar scanning technologies may be employed and/or included in the scanning device 110 in other embodiments.

Additionally, in this example embodiment, the database 104 may be further populated with other relevant data. In particular herein, the database 104 includes boundary data (e.g., for field 106, plots 108a-d, etc.), which defines the different fields, plots, etc., based on geographic coordinates. The database 104 may also include weather data for the specific field 106 (and other fields, etc.). The weather data, for example, may include solar angles, which may indicate thermal exposure of the crops in the plots 108a-d. The database 104 may also include crop data, which defines which crops are in which ones of the plots 108a-d, by variety (e.g., different hybrids, etc.). In this embodiment, the database 104 further includes historical data associated with the one or more of the plots 108a-d (and other plots in other fields). The historical data may include, without limitation, prior manual measurements by persons in the plots 108a-d of the heights (or other characteristics) of the crops in the plots 108a-d, which are associated with scan data for the same plots. The historical data may also include yield data for the plots 108a-d, for prior seasons, which may correspond to the scan data and/or the measurement data, etc. Moreover, the database 104 may include geographical characteristics for the field 106, the plots 108a-d, and/or the area including and/or surrounding the field 106 such as, for example, hydrologic/drainage data, soil attribute and general site/trial management practices/data, etc.

In connection therewith, the computing device 102 is configured to then access data included in the database 104, and to adjust the yield of the plots 108a-d of the field 106 based on the accesses data.

In particular, in this example embodiment, the computing device 102 is configured to align the scan data received from the scanning device 110 to form a monolithic and/or geometrically consistent data set, which is representative of the plot 108a, for example (and the other plots 108b-d, separately). The alignment may include compiling scan data from distinct scans, by the scanner 112, which are part of the same event, based on a physical location of the points included in the scan data for the different scans (e.g., based on location data received from the scanning device 110 with the scan data, as corrected, etc.), to form a composite data set, which is representative of the plot 108a (and other plots 108b-d), including the ground, the crops, etc.

Next, the computing device 102 is configured to classify the data in the composite data set, where each of the points is classified as ground or other (e.g., vegetation hits, canopy hits, outliers, etc.) and assessed for quality. For instance, for classifying points as ground, the computing device 102 may be configured to gather points which relate to one another by relative change in height, as compared to more distal potential members under defined (tuned) constraints. The computing device 102 may be configured to then perform a quality control analysis of the composite data set based on resulting ground slope estimates, to thereby reject data points that are above a threshold (e.g., that exhibit extreme slopes, etc.). Such assessment may provide confidence that the points are accurately classified as ground and not the underside of thick cover canopy, etc. In connection therewith, the computing device 102 may be configured to remove outlier data from the data set, or, potentially, to flag certain point data as anomalous data (e.g., for further review, etc.).

That said, in one example embodiment, the data points included in the composite data set may be classified, for example, using the simple morphological filter (SMRF) algorithm using parameters available from the point data abstraction library (PDAL), etc. In general, the SMRF algorithm utilizes four distinct stages: (1) creation of a minimum surface; (2) processing of the minimum surface, by identifying grid cells from a raster as either representing ground or not; (3) creating a digital elevation model (DEM) from the identified ground cells (e.g., a temporary or transitory DEM based on (or crated in connection with) application of the SMRF, etc.); and (4) identifying the original LiDAR points as either ground or not based on their relationship to the interpolated DEM (below).

Once classified, the computing device 102 is configured to generate a two-dimensional raster (or multiple two-dimensional rasters), to define a canopy height model (CHM). In particular, in this example embodiment, the computing device 102 is configured to interpolate the points within each class to define different surface models, after removing statistical outliers. The ground points are interpolated to form, in connection with generating the rasters, a DEM, while all hits are interpolated to generate a digital surface model (DSM). This allows for defining a relatively more restrictive filtering of the ground points to arrive at the DEM from a-priori awareness of the subject matter (e.g., a generally flat field, etc.) Then, the CHM is defined by Equation 1:

CHM=DSM−DEM (1)

In this manner, the CHM raster is based on the DSM and the DEM generated, formed, etc. following classification. The CHM raster includes the height above ground (HAG) values at each pixel (i.e., height per pixel), representative of each location of the given plot, for instance, plot 108a in this example (and also similarly for the other plots 108b-d). The CHM is then combined with metadata extracted from the plot specific data in the database 104 for the given plot 108a for further processing.

Finally, in connection with alignment, the CHM is overlaid on the plot geometries (e.g., location of plant rows, et.) derived or determined by the planter (e.g., as part of planting, etc.) for the field 106, or vice-versa. It should be appreciated that the overlay may confirm the position of the CHM relative to the plot geometries, directly, or may include adjustment of the positioning (e.g., by the computing device 102, by a user, etc.) to align the CHM with the plot geometries from the planter (not shown). In connection with the above, the computing device 102 may be configured to further clip or reduce the CHM based on the plot geometry (e.g., plot polygon, etc.), as necessary or desired.

It should be understood that the alignment in general may be performed otherwise in other embodiments, and the CHM may be expressed and/or derived otherwise, yet still representative of the canopy height of the specific plot.

After alignment of the composite data set, the computing device 102 is further configured to compute the plant heights (or plant height values) for the given plot 108a and to compute neighbor plant heights (or plant height values). In particular, the computing device 102 is configured to determine the plant heights of each of the plots 108a-d in the field 106. In doing so, the computing device 102 is configured to detect the number of rows in the given plot (and check the number of rows against planter data for the plot). The computing device 102 is configured to then select canopy hits in the CHM for the rows in each plot, in general, based on detected rows, plant spacing, etc., or other assessment of the CHM, etc. In this example embodiment, the computing device is configured to determine an aggregate plant height for each plot, which includes a mean of the plant heights corresponding to a threshold number of pixels (e.g., a mean of the maximum 25% (or maximum 50%, or maximum 75%, or any discrete percentage therebetween (or above/below)) of hits per row and/or pixels from identified rows of the given plot extracted from the CHM, etc.), etc. The aggregate may, of course, be determined otherwise in other embodiments including, for example, through directional histogram peak picking, etc.

The computing device 102 is then configured to compute the aggregate differences among neighboring plots. When an aggregate plant height is not known for a neighboring plot, the aggregate plant height for the field 106 may be used, or the aggregate differences may include only the differences between the plot and the one neighboring plot for which an aggregate plant height is known.

In this example embodiment, in connection with the above, the computing device 102 is configured to then compute a yield adjustment, based on the computed aggregate differences. For example, the computing device 102 may be configured to collate the computed aggregate differences for different plots in one or more different fields, generally, for the same variety of plant (i.e., the same experiment). In addition, the computing device 102 is configured to perform one or more data quality operations, such as, for example, filtering outliers among the aggregates and/or aggregate differences. The computing device 102 is also configured to fit a linear model to the data with yield response and neighboring plant height difference as a covariate, consistent with Equation 2.

Yᵢⱼ=μ+αᵢ+bⱼ+β*(Δ_1/2+Δ_r/2)+εᵢⱼ (2)

In Equation 2, Yᵢⱼ is the yield of the jth hybrid (or testing entry) in the ith field, Δ_1 is the difference between the given plot plant height and the left neighboring plot plant height, Δ_r is the difference between the given plot plant height and the right neighboring plot plant height, μ is the overall mean yield, αᵢ is the effect of the ith field, bⱼ is the effect of the jth hybrid, β is the effect of the covariate of (Δ_1/2+Δ_r/2), and εᵢⱼ is the residual of the jth hybrid (at the given plot) in the ith field.

The computing device 102 is configured to extract the plant height coefficients as the yield adjustment and to compute the adjusted yield values for various fields and/or plots based on the yield adjustment. The adjusted yield values may then be used by the computing device 102, or associated user (not shown) to advance ones of the varieties of crops included in the field 106, for example, over other in a breeding pipeline, based on enhanced performance of the ones of the varieties, etc. In this way, as a result of the above, certain ones of the varieties of crops included in the field 106 may be selected, over others, for subsequent production.

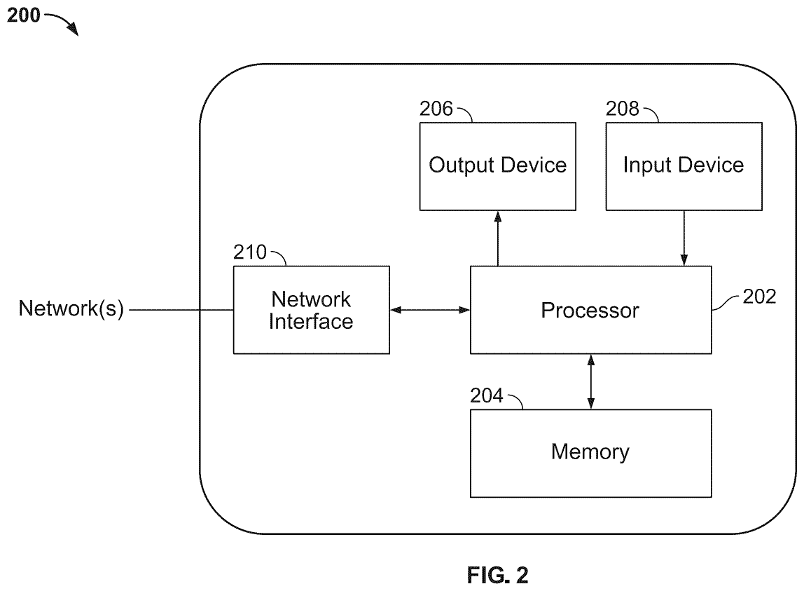

FIG. 2 illustrates an example computing device 200 that may be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity to each other or distributed over a geographic region, so long as the computing devices are specifically configured to operate as described herein.

In the example embodiment of FIG. 1, the computing device 102 includes and/or is implemented in one or more computing devices consistent with computing device 200. The database 104 may also be understood to include and/or be implemented in one or more computing devices, at least partially consistent with the computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including, without limitation, scan data, images (e.g., UAV images, etc.), image data, model architectures, parameters, crop data, field data, phenotypic data, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202 (e.g., a presentation unit, etc.). The output device 206 may output information (e.g., height coefficients, plant heights, etc.), visually or otherwise, to a user of the computing device 200, such as a researcher, grower, etc. It should be further appreciated that various interfaces (e.g., as defined by network-based applications, websites, etc.) may be displayed or otherwise output at computing device 200, and in particular at output device 206, to display, present, etc. certain information to the user. The output device 206 may include, without limitation, a liquid crystal display (LCD), a light-emitting diode (LED) display, an organic LED (OLED) display, an “electronic ink” display, speakers, a printer, etc. In some embodiments, the output device 206 may include multiple devices. Additionally or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of crops, fields, plots, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment the input device 208 may be integrated and/or included with the output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including the network 114 or other suitable network capable of supporting wired and/or wireless communication between the computing device 200 and other computing devices, including with other computing devices used as described herein (e.g., between the computing device 102, the database 104, etc.).

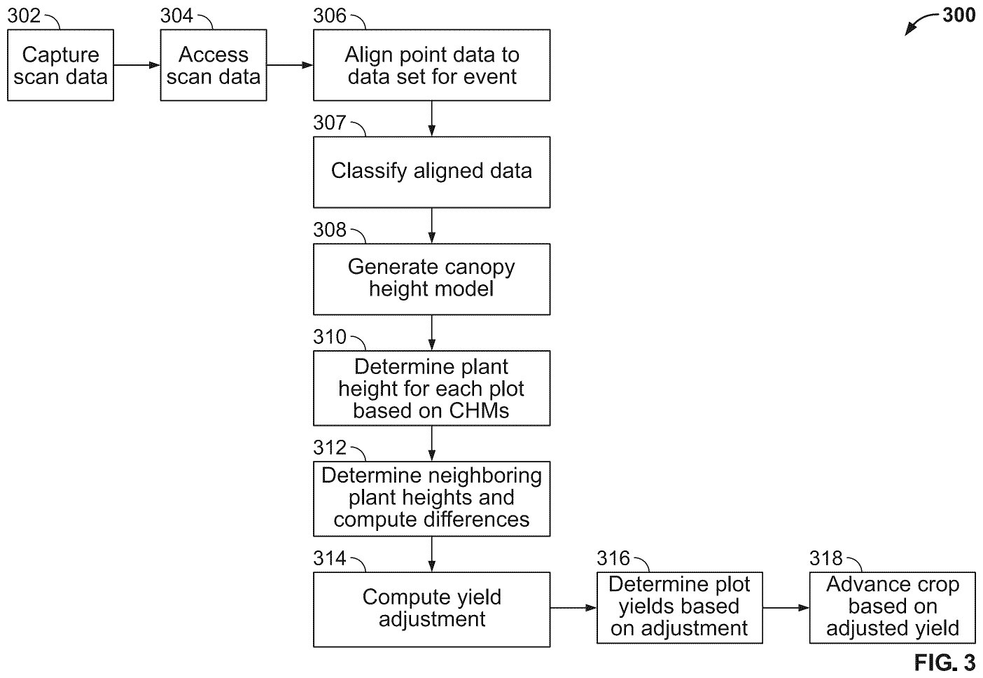

FIG. 3 illustrates an example method 300 for adjusting yield values for crops based on scan data associated with the crops. The example method 300 is described herein in connection with the system 100, and may be implemented, in whole or in part, for example, in the computing device 102 of the system 100. Further, for purposes of illustration, the example method 300 is also described with reference to the computing device 200 of FIG. 2. However, it should be appreciated that the method 300, or other methods described herein, are not limited to the system 100 or the computing device 200. And, conversely, the systems, data structures, and the computing devices described herein are not limited to the example method 300.

At the outset, it should be appreciated that the method 300 is directed, in the description below, to the plots 108a-d included in the field 106 in the system 100. However, the method 300 may be applied to additional, or different fields and/or plots in other embodiments.

Initially, the method 300 includes capturing, at 302, by the scanning device 110, scan data from the field 106, where the scan data, in this embodiment, includes LiDAR data indicative of surfaces (and/or surface features) of the field 106 (e.g., ground and ground features, vegetation, etc.). In particular, the scanning device 110 traverses the field 106, at a defined altitude (or range of altitudes), and captures point data for the field 106, via the scanner 112, as scan data for the field 106. The scan data includes multiple flight lines, as part of a scan event for the field 106 (e.g., as location data (e.g., x, y, z location data associated with each of the captured data points, etc.), etc.). The scan data may additionally include, for example, intensity, scan angle, laser id, return index, etc. for each data point, etc. In this example, the scanning device 110 is deployed to the field 106 generally later in the growth stage of the crop in the field 106, e.g., where the crop may be corn, etc., whereby a sufficient or maximum height of the crop is anticipated. The scan data for the event is transmitted, by the scanning device 110 (e.g., via network 114, etc.), and stored in the database 104 (e.g., directly or via the computing device 102, etc.).

In addition to the scan data, optionally, the method 300 may include capturing, via the scanning device 110, image data for the field 106 (e.g., RGB image data, etc.) as generally described above in the system 100.

After the scan data is captured, the computing device 102 accesses, at 304, the scan data for the scanning event, and potentially other data, from the database 104. The scan data may include a series of point cloud data, which includes point data for the individual scans of the event. The other data may include, without limitation, location data associated with the point cloud data, boundary data associated with the field 106 (and/or plots 108a-d in the field 106), planter and/or planting data for the field 106, plot definitions (e.g., variety of crop(s), treatments, etc.), and also weather data associated with the field 106 (e.g., solar data, temperature data, etc.), etc.

At 306, the computing device 102 aligns the scan data to form a composite data set. In particular, where the scan data for the event includes multiple passes (or scans) of (or by) the scanning device 110, the scan data is separated by the passes (or scans), but includes overlapping data for the field 106. The computing device 102 then aligns the scan data, based on physical location, to form the composite data set, which is indicative of the surface locations of the field 106, or a particular one or more of the plots 108a-d included therein. It should be appreciated that the scan data, as described herein, may be processed for the field 106 (or multiple fields) or separately for the plots 108a-d (e.g., for a single plot, for multiple plots, etc.). Regardless, the plot specific data is leveraged as described in more detail below.

In addition, at 307, the computing device 102 classifies the data in the composite data set, for example, where each of the points is classified as ground or other (e.g., vegetation hits, canopy hits, outliers, etc.) and, in some embodiments, further assessed for quality (as generally described above in the system 100). In classifying the data the computing device 102 may gather points that relate to one another by relative change in height, as compared to more distal potential members under defined (tuned) constraints. For instance, the computing device 102 may classify the data using the SMRF algorithm and parameters available from PDAL, etc.

Next, at 308, the computing device 102 generates a canopy height model (CHM) from the composite data set for a given one or more of the plots 108a-d (or for the field 106). In particular, each of the data points is classified, based on physical location, into one or more classes, such as, for example, ground, vegetation, outlier, etc. (e.g., as generally described above in the system 100, etc.). The computing device 102 then compiles and separates multiple two-dimensional images form the composite data set, based on the classification, as a mechanism to define an elevation model. The CHM is then derived by the computing device 102 as the height of the composite data for the vegetation above the ground/surface elevation (Equation 1). As such, the CHM is a two-dimensional image of canopy height, with specific pixels representing locations and the values of the pixel representing the height of the canopy above the ground at the location of the pixel. That said, it should be appreciated that the CHM may be derived from the composite data set in other ways in other embodiments, which may rely, for example, on row detection, planter data (e.g., row/plant location, etc.), etc.

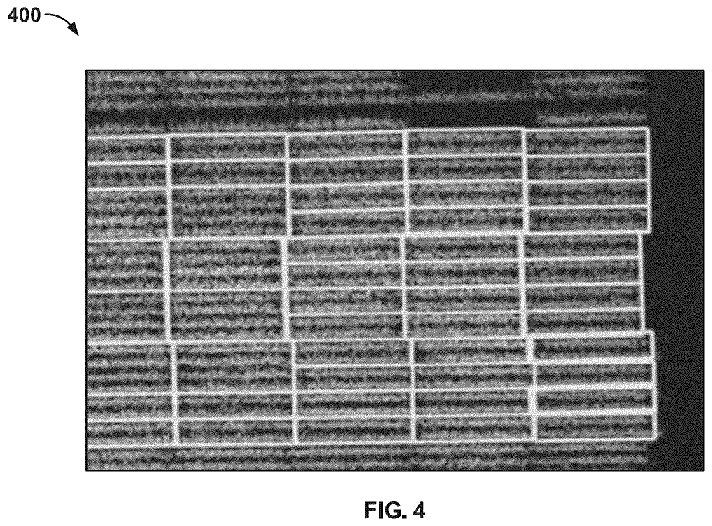

FIG. 4 illustrates an example canopy height model (raster), at 400, generated for an example field (e.g., field 106, etc.) in connection with the system 100 and method 300. As shown, the CHM includes orange colored regions indicative of the height of the vegetation in the field and then dark colored regions indicative of the ground, both of which are bounded by the plot geometries (e.g., plots as indicated by the generally rectangular boundary lines/grid, etc.) of the field (e.g., as defined by the planter during planting, etc.).

Referring again to FIG. 3, prior to continuing in method 300, the CHM may be overlaid on a geometry for the field 106 and/or the given one of the plots 108a-d (as defined by the planter of the field 106 (not shown)), for example, to verify that the CHM location corresponds to the location of the CHM relative to the geometry, and/or to adjust as necessary.

Then, at 310 in the method 300, the computing device 102 determines the plant height for each plot (in the field 106 or multiple fields) based on the CHM for the given plot (or for the field 106, etc.). More specifically, the CHM, for a given plot, is aggregated to one height for the plot. For example, where a CHM for a plot includes hundreds or thousands of pixels, and corresponding height values, the computing device 102 may determine the aggregate of at least a portion of the pixels (e.g., a top 25%, 50% or 75% of the pixel heights, etc.). The aggregate may be a mean, average, or other metric indicative of the height, as aggregated. For instance, in one embodiment directional histogram peak picking may be used, etc. In addition to the manner in which the heights are aggregated, the computing device 102 may further reduce the CHM. For example, the computing device 102 may employ row detection to limit the CHM by the location of the rows (e.g., based on planter and/or planting data, etc.) and/or may rely on plant detection to limit the CHM by the specific locations of plants based on row detection and plant spacing (from the planter). With row and/or plant detection, a tolerance may be applied to ensure heights of the plants in the rows in the given plot are retained in the CHM to properly represent the height of the plot.

It should be appreciated that the computing device 102 determines the aggregate plant height for each of the plots 108a-d, and other plots individually, so that the resulting plant height is plot specific. In at least one embodiment, the plant height for different plot that have the same variety of crop and/or same treatment, whereby consistent height is expected, may be combined (here or below) in method 300. That said, the determined aggregate plant heights are stored, by the computing device 102, in the database 104 for each plot of each field included in the scan data, or ones thereof, depending on potential use of the plant heights.

Thereafter, the computing device 102 determine, at 312, the neighboring plant heights for each of the plots. For example, for plot 108b, the computing device 102 determines the neighboring plant heights for plots 108a and plot 108c. It should be understood that, in one or more examples, plots may be sequentially identified (e.g., plot 101, plot 102, plot 103, etc.), whereby identifying neighboring plots may be the prior and the next sequent plots, in one direction or multiple directions. In any case, once the plots are identified, the computing device 102 retrieves the plant heights determined for the plots and computes, at 312, the difference between the determined plant heights (e.g., differences of the means, etc.). The differences between the neighboring plots are then stored, by the computing device 102, in the database 104.

Once the neighboring plant height differences are determined for the plots 108a-d and other plots, optionally, the computing device 102 may process and filter the differences to eliminate outliers of the data. For example, outliers may be eliminated relying on interquartile ranges, where a right most and left most quartile of difference values are eliminated. It should be appreciated that other techniques may be employed to eliminate, or reduce outlier differences, prior to proceeding in method 300.

Next, at 314, the computing device 102 computes, at 314, a yield adjustment for each of the plots. In particular, in this example embodiment, the computing device 102 fits a linear model to the data, with yield as a response and neighboring plant height (npht) as a covariate, through Equation 2 above. Fit data in the instant example constitutes all entries of a distinctive study sub-set, be it by genetics, or otherwise, across one or more observational geographic locations. The value of the fixed effect coefficient for npht delta, from the linear model, is referred to as a “beta”. This beta is the factor to be used for yield adjustments for plots. Then, to determine the plot yields, at 316, the yield adjustment is multiplied by the computing device 102, by the npht_delta for each plot to get the yield adjustment factor, which is then added to the yield for the specific plot to attain the adjusted yield value.

Finally, in the method 300, the varieties included in the plots 108a-d, are either selected to be advanced, at 318, for example, in a breeding pipeline, based on the adjusted yield for the plot, or not, when the adjusted yield demonstrates a desired or relative performance (e.g., relative to a threshold, etc.). In addition, in some example embodiments, the adjusted yield may be considered in combination with other phenotypes of interest of the crops in making the decision on advancement, for example, lodging, green snap resistance, drought resistance, etc.

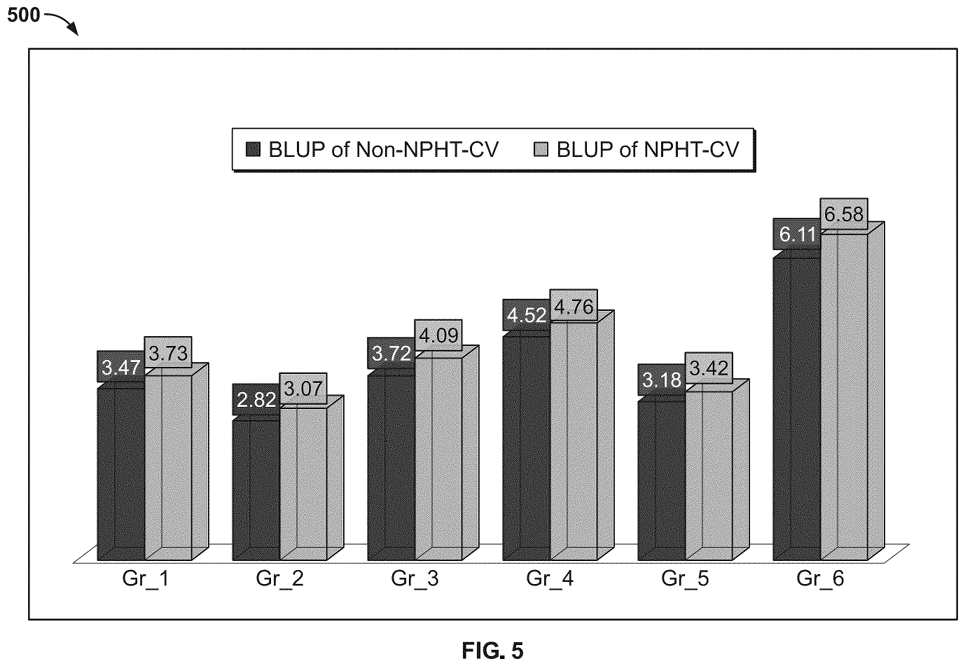

In connection with the above, FIG. 5 illustrates (at 500) example BLUP values for yield values for crops adjusted in accordance with the present disclosure, based on scan data (e.g., LiDAR data, etc.) from fields in which the crops are disposed (identified as BLUP of NPHT-CV in FIG. 5), and BLUP values for yield values for crops that are not adjusted based on such scan data (identified as BLUP of Non-NPHT-CV in FIG. 5). As can be seen, for each group/comparison (Gr_1 to Gr_6), the BLUP value for the yield value that is not adjusted is less (or smaller) than the BLUP value for the yield value that is adjusted. In particular in this example, for each of the groups, the adjusted yield values resulted in a generally consistent increase in mean yield of the top 15% of the cohort being tested. As can be appreciated, such improved yield values may provide enhanced, improved, etc. selection precision of seeds, crops, etc. and an improved ability to separate genetics (e.g., enhanced genome wide selection predictability, etc.).

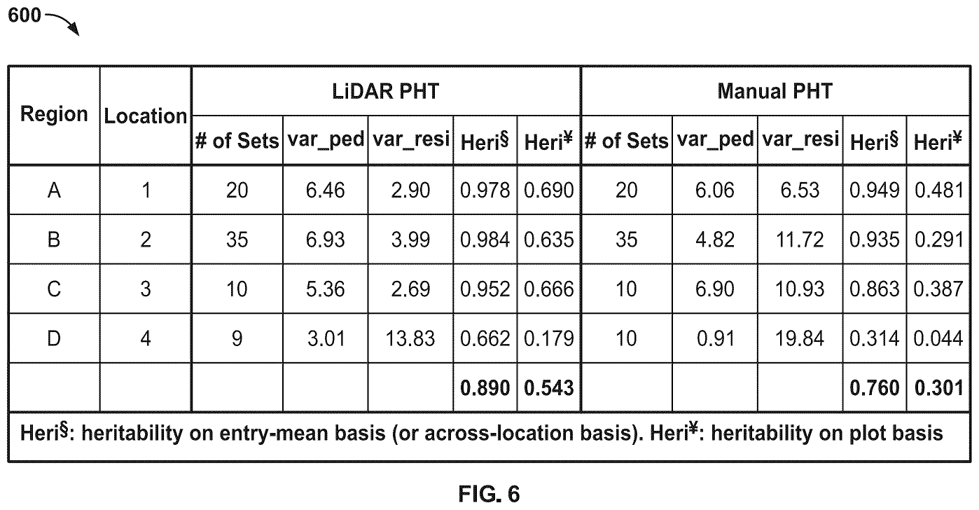

FIG. 6 illustrates (at 600) example heritability/repeatability values associated with determined plant height values at various different regions and locations (regions A-D and corresponding locations 1-4). In particular, FIG. 6 illustrates (for each region and corresponding location) such heritability/repeatability values for plant height values obtained based on scan data herein (e.g., based on LiDAR data as described herein, etc.) (identified as LiDAR PHT in FIG. 6), and heritability/repeatability values associated with plant height values obtained through manual measurements (identified as Manual PHT in FIG. 6). In doing so, for both the LiDAR data and the manual data, multiple sets of evaluations were performed for each region and corresponding location, resulting in values for: a variance among the tested entries (or the tested pedigrees) (“var_ped”), a variance of the residual from the model (“var_resi”), a first heritability feature (“Heri^{§}”) (e.g., heritability on entry-mean basis, etc.), and a second heritability feature (“Heri^{¥}”) (e.g., heritability on plot basis, etc.). In connection therewith, the first heritability feature (“Heri^{§}”) may be calculated as follows, where N is a number of replications (or number of sets in FIG. 6):

Heri=Var_ped/(Var_ped+var_resi/N)

And, the second heritability feature (“Heri^{¥}”) may be calculated as follows:

Heri=Var_ped/(Var_ped+var_resi)

In all cases, the scan data provided higher heritability/repeatability values, indicating enhanced measuring of plant height in relation to true genetic variance, whereby the resulting plant height values may be used as a basis for subsequent selection decisions of the crops (e.g., versus environment noise, measurement error, etc.).

In view of the above, the systems and methods herein may provide for adjusting yield values for crops based on scan data associated with the crops. To this point, plant height is an important phenotype for selection in plant breeding programs and is known to correlate well with yield. Traditionally, plant height measurements have been taken manually with measuring rods, which is prone to error, challenging to scale, and requires personnel to spend extensive time in the field in high temperatures. In addition, in small plot formats such as those used in crop research and development programs, differences in plant height and other structural characteristics between neighboring plots being evaluated may cause competition effects that create noise in yield data. As an example, taller plots may have an unfair and unrepresentative yield advantage when placed next to shorter plots, not originally taken into consideration in conventional breeding yield models. Further, other late season metrics that are conventionally recorded manually, such as lodging damages, pivot track damages etc., that may affect yield may also not be scalable. As such, the systems and methods herein provide for adjusting yield values for the crops, to account for such impact of neighboring crops and also impact of potential human error in collecting data relating thereto.

In connection therewith, the systems and method herein may provide for an automated pipeline for high throughput plant height measurements at a scale of millions of plots per year (as compared to hundreds or thousands of plots per year by manual measurement, at significantly higher resources). The systems and methods herein may provide automatic determination of neighboring plant heights for every plot in a field and/or system of fields, to thereby utilize the neighboring plant heights to make covariance adjustments to the yield to facilitate genome wide selection accuracy, which is made possible with the availability of plant height metrics for all relevant plots in the field. From the volume of point cloud data collected, the systems and methods herein may enable late season uniformity of plots to be determined based on the plant height variance within plots. That said, the plant height variance within plots may be due to various in-season events such as green snap, lodging, planter issues, pivot tracks etc., where the late season uniformity metrics to quantize these damages have a direct correlation with yield. From the height profile of the plot, generated using the LiDAR point data, depending on the height variance, the systems and methods herein may provide insights to quantize these damages that may have occurred to a plot prior to the later season scanning described herein. The systems and methods herein may further provide insights into the differences in plant height and other structural characteristics between neighboring plots causing competition effects that create noise in yield data.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) classifying data points of a composite data set into one of multiple classes, the composite data set specific to a plot, each of the data points specific to a surface location of the plot, the multiple classes including a ground class and a vegetation class; (b) determining a canopy height model (CHM) for said plot based on the classified composite data set, the CHM including at least one of the data points classified in the vegetation class; (c) computing a plant height for the plot based on the CHM; (d) determining a neighboring plant height difference based on the plant height for the plot and a plant height for each of at least one neighboring plot to said plot; (e) computing a yield adjustment based on the determined neighboring plant height difference(s); and/or (f) determining a plot yield for the plot, based on the yield adjustment.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in adjusting yield values for crops based on scan data associated with the crops, the method comprising:
determining, by a computing device, a canopy height model (CHM) for a plot;
computing, by the computing device, a plant height for the plot based on the CHM;
determining, by the computing device, a neighboring plant height difference based on the plant height for the plot and a plant height for each of at least one neighboring plot to said plot;
computing, by the computing device, a yield adjustment based on the determined neighboring plant height difference(s); and
determining, by the computing device, a plot yield for the plot, based on the yield adjustment.

2. The computer-implemented method of claim 1, further comprising classifying, by the computing device, data points of a composite data set into one of multiple classes, the composite data set specific to the plot, each of the data points specific to a surface location of the plot, the multiple classes including a ground class and a vegetation class; and
wherein determining the CHM for the plot includes determining the CHM based on the classified composite data set, and wherein the CHM includes at least one of the data points classified in the vegetation class.

3. The computer-implemented method of claim 2, wherein the scan data includes scan data for multiple scans; and
wherein the method further comprises aligning the scan data, based on common locations among the point location data in the scan data for the multiple scans, into the composite data set.

4. The computer-implemented method of claim 3, wherein the multiple classes further include an outlier class; and
wherein the method further comprises filtering out the data points classified into the outlier class.

5. The computer-implemented method of claim 4, wherein computing the plant height for the plot includes computing a mean of a portion of the data points included in the CHM.

6. The computer-implemented method of claim 5, wherein determining the neighboring plant height difference includes determining a difference between the plant height of said plot and the plant height for each of two neighboring plots to said plot.

7. The computer-implemented method of claim 1, further comprising:
traveling, by a scanning device, to the plot, the scanning device including a light detection and ranging (LiDAR) scanner; and
capturing, by the LiDAR scanner, scan data for the plot during a scan event, the scan data including point location data for the plot.

8. The computer-implemented method of claim 1, further comprising:
directing, by the computing device, a scanning device to the plot, the scanning device including a light detection and ranging (LiDAR) scanner; and
capturing, by the LiDAR scanner, scan data for the plot during a scan event, the scan data including point location data for the plot.

9. The computer-implemented method of claim 1, wherein determining the CHM includes:
determining a digital elevation model (DEM) for the plot and a digital surface model (DSM) for the plot; and
determining the CHM based on a difference between the DEM and the DSM.

10. The computer-implemented method of claim 1, wherein computing the yield adjustment includes computing the yield adjustment based on:
Yᵢⱼ=μ+αᵢ+bⱼ+β*(Δ_1/2+Δ_r/2)+εᵢⱼ;
wherein Yᵢⱼ is the yield of the jth plant in the ith plot, Δ_1 is the difference between the given plot plant height and the left neighboring plot plant height, Δ_r is the difference between the given plot plant height and the right neighboring plot plant height, μ is the overall mean yield, αᵢ is the effect of the ith plot, bⱼ is the effect of the jth plant, β is the effect of the covariate of (Δ_1/2+Δ_r/2), and εᵢⱼ is a residual of the jth plant in the ith plot.

11. The computer-implemented method of claim 1, further comprising selecting a crop included in the plot, based on the plot yield for the plot, to advance in a breeding pipeline.

12. The computer-implemented method of claim 1, wherein the yield adjustment is specific to said plot.

13. A non-transitory computer-readable storage medium including executable instructions for use in adjusting yield values for crops based on scan data associated with the crops, which when executed by at least one processor, cause the at least one processor to:
determine a canopy height model (CHM) for a plot;
compute a plant height for the plot based on the CHM;
determine a neighboring plant height difference based on the plant height for the plot and a plant height for each of at least one neighboring plot to said plot;
compute a yield adjustment based on the determined neighboring plant height difference(s); and
determine a plot yield for the plot, based on the yield adjustment.

14. The non-transitory computer-readable storage medium of claim 13, wherein the executable instructions, when executed by the at least one processor, further cause the at least one processor to classify data points of a composite data set into one of multiple classes, the composite data set specific to the plot, each of the data points specific to a surface location of the plot, the multiple classes including a ground class and a vegetation class; and
wherein the executable instructions, when executed by the at least one processor to determine the CHM for the plot, cause the at least one processor to determine the CHM based on the classified composite data set, and wherein the CHM includes at least one of the data points classified in the vegetation class.

15. The non-transitory computer-readable storage medium of claim 14, wherein the executable instructions, when executed by the at least one processor to compute the yield adjustment, cause the at least one processor to compute the yield adjustment based on:
Yᵢⱼ=μ+αᵢ+bⱼ+β*(Δ_1/2+Δ_r/2)+εᵢⱼ;
wherein Yᵢⱼ is the yield of the jth plant in the ith plot, Δ_1 is the difference between the given plot plant height and the left neighboring plot plant height, Δ_r is the difference between the given plot plant height and the right neighboring plot plant height, μ is the overall mean yield, αᵢ is the effect of the ith plot, bⱼ is the effect of the jth plant, β is the effect of the covariate of (Δ_1/2+Δ_r/2), and εᵢⱼ is a residual of the jth plant in the ith plot.

16. The non-transitory computer-readable storage medium of claim 15, wherein the executable instructions, when executed by the at least one processor, further cause the at least one processor to direct a scanning device to the plot, the scanning device including a light detection and ranging (LiDAR) scanner operable to scan data for the plot during a scan event, the scan data including point location data for the plot.

17. A system for use in adjusting yield values for crops based on scan data associated with the crops, the system comprising a computing device, which is configured, by executable instructions, to:
determine a canopy height model (CHM) for a plot;
compute a plant height for the plot based on the CHM;
determine a neighboring plant height difference based on the plant height for the plot and a plant height for each of at least one neighboring plot to said plot;
compute a yield adjustment based on the determined neighboring plant height difference(s); and
determine a plot yield for the plot, based on the yield adjustment.

18. The system of claim 17, wherein the computing device is further configured, by the executable instructions, to classify data points of a composite data set into one of multiple classes, the composite data set specific to the plot, each of the data points specific to a surface location of the plot, the multiple classes including a ground class and a vegetation class; and
wherein the computing device is configured, in order to determine the CHM for the plot, to determine the CHM based on the classified composite data set, and wherein the CHM includes at least one of the data points classified in the vegetation class.

19. The system of claim 17, further comprising a scanning device including a light detection and ranging (LiDAR) scanner; and
wherein the scanning device is configured to capture, by the LiDAR scanner, scan data for the plot during a scan event, the scan data including point location data for the plot.

20. The system of claim 17, wherein the computing device is configured, in order to compute the yield adjustment, to compute the yield adjustment based on:
Yᵢⱼ=μ+αᵢ+bⱼ+β*(Δ_1/2+Δ_r/2)+εᵢⱼ;
wherein Yᵢⱼ is the yield of the jth plant in the ith plot, Δ_1 is the difference between the given plot plant height and the left neighboring plot plant height, Δ_r is the difference between the given plot plant height and the right neighboring plot plant height, μ is the overall mean yield, αᵢ is the effect of the ith plot, bⱼ is the effect of the jth plant, β is the effect of the covariate of (Δ_1/2+Δ_r/2), and εᵢⱼ is a residual of the jth plant in the ith plot.
